(19) United States
(12) Patent Application Publication
(10) Pub. No.: US 2023/0191526 A1
(43) Pub. Date: Jun. 22, 2023

(54) METHOD FOR PRODUCING RESISTANCE-WELDED MEMBER

(71) Applicant: Kabushiki Kaisha Kobe Seiko Sho (Kobe Steel, Ltd.), Kobe-shi (JP)

(72) Inventors: Kyohei MAEDA, Kanagawa (JP); Reiichi SUZUKI, Kanagawa (JP); Ryohei IHARA, Hyogo (JP)

(73) Assignee: Kabushiki Kaisha Kobe Seiko Sho (Kobe Steel, Ltd.), Kobe-shi (JP)

(21) Appl. No.: 17/996,312

(22) PCT Filed: Apr. 12, 2021
(86) PCT No.: PCT/JP2021/015192

§ 371 Date: Oct. 14, 2022

(30) Foreign Application Priority Data
Apr. 15, 2020 (JP) 2020-073126

(51) Int. Cl. B23K 11/31

(52) U.S. Cl. CPC B23K 11/31; B23K 2101/18

(57) ABSTRACT

A method for producing a resistance-welded member made of three or more sheets including a plated steel sheet that includes: a first energizing with a first current value while compressing the steel sheets with a first compressive force to form a nugget; a subsequent energizing of, after the first energizing, energizing with a second current value smaller than the first current value while compressing the steel sheets with a second compressive force greater than the first compressive force; and holding an electrode by maintaining the second compressive force after the subsequent energization. The second compressive force and a total sheet thickness, the first current value and the second current value, and a subsequent energization time and an electrode holding time satisfy predetermined conditions respectively.

### TECHNICAL FIELD

The present invention relates to a method for producing a resistance-welded member, and more particularly, to a method for producing a resistance-welded member in which spot welding is performed by sandwiching and energizing, with a pair of electrodes, both surfaces of a set of three or more sheets including at least one plated steel sheet.

### BACKGROUND ART

In a plated high-tensile steel sheet, a molten metal brittle crack (hereinafter also referred to as LME crack) occurs at a welded portion due to components in steel. In particular, in the case of a set of three or more sheets, an internal crack of a nugget and a crack originating from the inside of a corona bond (hereinafter, also referred to as an internal crack of a corona bond) are likely to occur. Patent Literature 1 describes a spot welding method in which, in spot welding of a set of sheets including a galvanized steel sheet, an after-weld holding time from the end of welding energization between welding electrodes to a time point when the welding electrode and a member to be welded are not in contact with each other is set in accordance with a total sheet thickness of the steel sheets, whereby even when a disturbance factor is present, cracks just outside a corona bond and at a nugget of a corona bond can be suppressed, and a high-quality spot welded joint can be obtained.

### CITATION LIST

### Patent Literature

Patent Literature 1: JP-A-2017-47475

### SUMMARY OF INVENTION

### Technical Problem

However, in the spot welding of a set of three or more sheets, it is difficult to prevent the LME crack only by controlling the after-weld holding time described in Patent Literature 1. In addition, Patent Literature 1 does not specify the presence or absence of a compressive control and a relationship between subsequent energization and a holding time at all, and there is room for improvement.

The present invention has been made in view of the above-described problems, and an object of the present invention is to provide a method for producing a resistance-welded member by which an internal crack of a nugget and an internal crack of a corona bond can be suppressed in spot welding of a set of three or more sheets including at least one plated steel sheet.

### Solution to Problem

Accordingly, the above object of the present invention is attained with a configuration of the following (1) related to a method for producing a resistance-welded member.

(1) A method for producing a resistance-welded member made of three or more steel sheets including at least one plated high-tensile steel sheet having a base metal strength of 980 MPa or more, the method including:

a main energization step of performing energization with a first current value I1 while compressing the steel sheets with a first compressive force P1 to form a nugget;

a subsequent energization step of performing, after the main energization step, energization with a second current value I2 smaller than the first current value I1 while compressing the steel sheets with a second compressive force P2 greater than the first compressive force P1; and

an electrode holding step of holding an electrode while maintaining the second compressive force P2 after the subsequent energization, wherein

the steel sheets are joined under conditions satisfying following formulae (1) to (3):

A≥1.4 Formula (1)

where A=P2/t, P2 represents the second compressive force [kN], and t represents a total sheet thickness [mm] of the steel sheets, respectively,

B<0.7 Formula (2)

where B=I2/I1, I1 represents the first current value [kA], and I2 represents the second current value [kA], respectively, and

C≤Tw2<1000 Formula (3)

where C=0.0039Tht²−2.51Tht+581.3, Tw2 represents an energization time [ms] in the subsequent energization step, and Tht represents an electrode holding time [ms] in the electrode holding step, respectively.

Further, preferred embodiments of the present invention related to a method for producing a resistance-welded member relates to following (2) to (4).

(2) The method for producing a resistance-welded member according to (1), wherein the Tw2 and the Tht satisfy the following formula (4):

D≤Tw2<1000 Formula (4)

where D=0.0063Tht²−4.32Tht+923.87.

(3) The method for producing a resistance-welded member according to (1) or (2), wherein a compression rise delay time Td1 which is a time difference between an end of energization with the first current value I1 and a start of compression with the second compressive force P2 satisfies the following formula (5):

−100≤Td1≤300 Formula (5)

where Td1 represents the compression rise delay time [ms].

(4) The method for producing a resistance-welded member according to any one of (1) to (3), wherein

a servo compression welding machine is used as a welding machine, and

when a depth of an indentation on the steel sheet by the electrode becomes 0.15 mm or more, control is performed to forcibly terminate only the energization or both the energization and the compression.

### Advantageous Effects of Invention

According to the method for producing a resistance-welded member of the present invention, a main energization step of performing energization with a first current value I1 while compressing a steel sheet with a first compressive force P1; a subsequent energization step of performing, after the main energization step, energization with a second current value I2 smaller than the first current value I1 while compressing with a second compressive force P2 greater than the first compressive force P1; and an electrode holding step of holding an electrode while maintaining the second compressive force (P2) after the subsequent energization are provided, and the compressive force is increased during the subsequent energization step. Therefore, even when spot welding three or more plated high-tensile steel sheets having a base metal strength of 980 MPa or more, contraction of a nugget can be suppressed and a tensile stress acting on a welded portion can be reduced.

In addition, by controlling the second compressive force P2 and a total sheet thickness t of the steel sheets, the first current value I1 and the second current value I2, and an energization time Tw2 of the subsequent energization and an electrode holding time Tht after the end of the subsequent energization so as to satisfy a predetermined relationship, the temperature of the welded portion and the tensile stress at the time of electrode opening can be optimized, and thus the internal crack of a nugget and the internal crack of a corona bond can be suppressed.

### BRIEF DESCRIPTION OF DRAWINGS

FIG. 1 is a graph of an energization pattern showing a relationship between a current value and a compressive force in a main energization step, a subsequent energization step, and an electrode holding step.

FIG. 2 is a graph of an experimental result showing a relationship between an electrode holding time Tht and a subsequent energization time Tds and presence or absence of an LME crack.

FIG. 3 is a cross-sectional photograph (drawing substitute photograph) showing a welded portion of Example 1.

FIG. 4 is a cross-sectional photograph (drawing substitute photograph) showing a welded portion of Comparative Example 1.

FIG. 5 is a cross-sectional photograph (drawing substitute photograph) showing a welded portion of Example 6.

FIG. 6 is a cross-sectional photograph (drawing substitute photograph) showing a welded portion of Example 14.

FIG. 7 is a cross-sectional photograph (drawing substitute photograph) showing a welded portion of Comparative Example 2.

FIG. 8 is a cross-sectional photograph (drawing substitute photograph) showing a welded portion of Comparative Example 4.

FIG. 9 is a cross-sectional photograph (drawing substitute photograph) showing a welded portion of Comparative Example 6.

FIG. 10 is a cross-sectional photograph (drawing substitute photograph) showing a welded portion of Comparative Example 10.

FIG. 11 is a cross-sectional photograph (drawing substitute photograph) showing a welded portion of Comparative Example 11.

### DESCRIPTION OF EMBODIMENTS

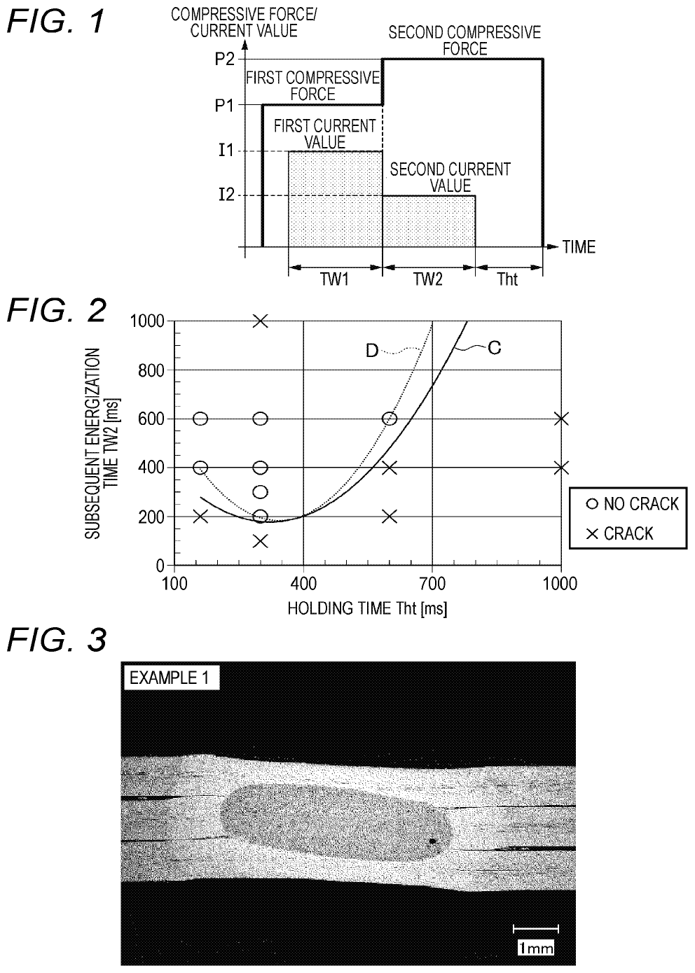

Hereinafter, a method for producing a resistance-welded member according to the present invention will be described in detail with reference to the drawings. FIG. 1 is a graph showing a relationship between a current value and a compressive force in a main energization step, a subsequent energization step, and an electrode holding step in the method for producing a resistance-welded member of the present invention.

The method for producing a resistance-welded member according to the present invention is a producing method in which a resistance-welded member (member to be welded) formed of three or more plated high-tensile steel sheets including at least one plated high-tensile steel sheet having a base metal strength of 980 MPa or more is subjected to a main energization step, a subsequent energization step, and an electrode holding step, thereby welding the resistance-welded member.

Specifically, the main energization is performed by stacking and sandwiching three or more plated high-tensile steel sheets with a pair of welding electrodes, and performing energization with a first current value I1 for an energization time Tw1 while compressing with a first compressive force P1. Next, the subsequent energization is performed by performing energization for an energization time Tw2 with a second current value I2 smaller than the first current value I1 while compressing with a second compressive force P2 greater than the first compressive force P1. Then, while maintaining the second compressive force P2, the welding electrodes and the plated high-tensile steel sheet are not in contact with each other (that is, the electrode is opened) after the elapse of an electrode holding time Tht from the end of the subsequent energization, and the plated high-tensile steel sheets are resistance-welded.

In the method for producing a resistance-welded member according to the present invention, each parameter is controlled so as to satisfy the following formulae (1) to (3) during the above-described resistance welding.

A≥1.4 Formula (1)

Where A=P2/t, P2 represents the second compressive force [kN], and t represents a total sheet thickness [mm] of the steel sheets, respectively.

B<0.7 Formula (2)

Where B=I2/I1, I1 represents the first current value [kA], and I2 represents the second current value [kA], respectively.

C≤Tw2<1000 Formula (3)

Where C=0.0039Tht²−2.51Tht+581.3, Tw2 represents the energization time [ms] in the subsequent energization step, and Tht represents the electrode holding time [ms] in the electrode holding step, respectively.

In the method for producing a resistance-welded member according to the present invention, each parameter is controlled so as to satisfy the following formula (4) or (5) as a preferable condition during the above-described resistance welding.

D≤Tw2<1000 Formula (4)

Where D=0.0063Tht²−4.32Tht+923.87.

−100≤Td1≤300 Formula (5)

Where Td1 represents a compression rise delay time [ms] which is a time difference between the end of energization with the first current value I1 and the start of compression with the second compressive force P2.

### <Regarding Formula (1)>

During the above-described resistance welding, by performing the welding under the condition satisfying the formula (1), contraction of a nugget can be sufficiently suppressed even in the resistance welding of three or more plated high-tensile steel sheets, and as a result, the tensile stress generated in the nugget or inside of a corona bond is reduced. The upper limit of the second compressive force P2 is not particularly limited, but when the second compressive force P2 is 15 kN or more, the welding electrode may be excessively deformed, and thus P2<15 kN is preferable.

### <Regarding Formula (2)>

The subsequent energization has an effect of gradually cooling the welded portion, and a temperature gradient in the joint is reduced, so that the tensile stress generated in the nugget or the inside of the corona bond at the time of electrode opening can be reduced. When the subsequent energization time Tw2 is too small, the effect of slow cooling cannot be obtained. On the other hand, when the subsequent energization time Tw2 is too large, the temperature at the time of electrode opening becomes high, and the breaking stress of the welded portion becomes low. Therefore, it is preferable to set the subsequent energization time Tw2<1000 ms.

Similarly, when the second current value I2 of the subsequent energization is too high with respect to the first current value I1 of the main energization, the effect of slow cooling cannot be obtained. Therefore, it is necessary to control the first current value I1 and the second current value I2 within the range of the formula (2). Although the lower limit of the second current value I2 is not particularly determined, it is assumed that 2 kA<I2 because it is difficult to control the second current value I2 to 2 kA or less due to the characteristics of the welding machine.

### <Regarding Formula (3) and Formula (4)>

When the electrode holding time Tht is prolonged, the temperature of the welded portion at the time of electrode opening is lowered. As a result, an amount of molten zinc causing a crack is reduced, and the breaking stress of the welded portion is increased. On the other hand, since the temperature gradient in the joint becomes large, the tensile stress generated in the nugget or the inside of the corona bond at the time of electrode opening increases.

For the reason described above, as shown in the result of Example described later (see FIG. 2), there is an appropriate condition range for the subsequent energization time Tw2 and the electrode holding time Tht. This appropriate condition is a condition satisfying the formula (3), and preferably a condition satisfying the formula (4).

### <Regarding Formula (5)>

It is preferable that the compression rise delay time Td1, which is a time difference between the end of energization with the first current value I1 and the start of compression with the second compressive force P2, is controlled to fall within a condition range satisfying the formula (5). The compression rise delay time Td1 is set to a negative value when the second compressive force P2 rises before the end of the energization with the first current value I1, and is set to a positive value when the second compressive force P2 rises after the end of the energization with the first current value I1.

When the Td1 is less than −100 ms, rising of the compressive force occurs before the nugget starts to contract, and thus the effect of reducing the tensile stress generated in a heat-affected zone may not be obtained. In addition, when the Td1 exceeds 300 ms, the nugget has a large number of solidified portions and the rigidity thereof is increased, and thus the contraction cannot be sufficiently suppressed, and the intended effect may not be obtained.

### <Regarding Control of Displacement Amount of Electrode>

When compression is performed during the energization, the nugget may be crushed more than necessary, and the melted metal may be discharged to the outside, that is, so-called expulsion may occur since the rigidity of the melted nugget is low. At the same time, a depth of an indentation formed on the steel sheet by the electrode (that is, an amount of penetration into the steel sheet by the electrode) is increased, and the LME crack is likely to occur in the electrode indentation portion and the periphery thereof. In order to effectively prevent this, it is preferable that the maximum displacement amount of the electrode is set to a predetermined numerical value in advance, and specifically, when the depth of the indentation on the steel sheet by the electrode becomes 0.15 mm or more, electrical displacement control is performed using a servo compression welding machine as a welding machine, for example, in order to forcibly terminate energization only or energization and compression, thereby suppressing deformation of the nugget more than necessary, and further deformation of the indentation portion associated therewith, thereby suppressing occurrence of expulsion. This makes it possible to effectively prevent occurrence of expulsion even when the compression is performed with the second compressive force.

### Example

In order to confirm the effects of the present invention, Examples of the method for producing a resistance-welded member according to the present invention and Comparative Examples to be compared with Examples will be described.

### [Test Material]

Two types of plated steel sheets described below were used as test materials used for welding.

Abbreviation S1: 980 MPa grade GA plated steel sheet (Ceq=0.38), sheet thickness: 1.0 mm

Abbreviation S2: 980 MPa grade GA plated steel sheet (Ceq=0.38), sheet thickness: 1.4 mm

Carbon equivalent Ceq=C+Si/30+Mn/20+2P+4S. The element symbol in the above formula represents the content (mass %) of each element, and the content of an element is set to 0 when the element is not contained.

### [Welding Conditions]

The following conditions were common to all Examples and Comparative Examples.

Set: three sheets of the same kind of material

Welding machine: servo compression single-phase alternating current welding machine

Tilt angle: 5°

Sheet gap: 1 mm between sheets

Electrode: DR (dome radial) electrode made of chromium copper for both upper and lower electrodes
(Tip end diameter: 6 mm, tip end curvature radius: 40 mm)

A type of the steel sheet as the test material, a total sheet thickness t of the overlapped steel sheets, a first compressive force P1 [kN], a second compressive force P2 [kN], a first current value I1 [kA], a main energization time Tw1 [ms], a second current value I2 [kA], a subsequent energization time Tw2 [ms], a compression rise delay time Td1 [ms], and an electrode holding time Tht [ms] were set as shown in Table 1 in each of Examples and Comparative Examples.

It should be noted that the electrode holding time Tht is an actually measured value, and a compressive force measured by a load cell incorporated in a welding machine and a current value measured by a weld checker were read into a data logger, and the obtained voltage value was converted and measured. In addition, a time point at which an absolute value of the current value became 0.1 kA or less was defined as a start time point of the electrode holding time, and a time point at which the compressive force became 1 kN or less was defined as an end time point of the electrode holding time.

A cross section of the obtained resistance-welded joint was macroscopically observed by etching using a picric acid saturated aqueous solution, and the presence or absence of an internal crack of a nugget and an internal crack of a corona bond was examined. The observation magnification was 10 times. In addition, regarding the evaluation of the internal crack of a nugget and the internal crack of a corona bond, a sample in which no crack occurred was evaluated as “∘” (good), and a sample in which a crack occurred was evaluated as “x” (poor).

The evaluation results of the internal crack of a nugget and the internal crack of a corona bond in each Example and Comparative Example are shown in Table 1 together with the welding conditions. FIG. 2 shows a relationship between the electrode holding time Tht and the subsequent energization time Tw2 and the presence or absence of a crack in a part of each Example and Comparative Example. In FIG. 2, “∘” indicates that neither the internal crack of a nugget nor the internal crack of a corona bond occurred, and “x” indicates that at least one of the internal crack of a nugget and the internal crack of a corona bond occurred. Furthermore, “A” to “D” in Table 1 represent the following, respectively, as explained in the above formulae (1) to (4).

A=P2/t

B=I2/I1

C=0.0039Tht²−2.51Tht+581.3

D=0.0063Tht²−4.32Tht+923.87

TABLE 1

| | | | Compressive force | | | | Main energization | |
|---|---|---|---|---|---|---|---|---|
| | | Total | First | Second | | Compression | First | |
| | | sheet | compressive | compressive | | rise delay | current | Energization |
| | Steel | thickness t | force P1 | force P2 | | time Tdl | value I1 | time TW1 |
| | sheet | [mm] | [kN] | [kN] | A | [ms] | [kA] | [ms] |
| Example 1 | S1 | 3 | 5 | 8 | 2.7 | 0 | 5 | 400 |
| Example 2 | S1 | 3 | 3 | 6 | 2.0 | 0 | 5 | 400 |
| Comparative | S1 | 3 | 5 | No | — | — | 5 | 400 |
| Example 1 | | | | | | | | |
| Example 3 | S2 | 4.2 | 5 | 8 | 1.9 | 0 | 5.5 | 400 |
| Example 4 | S2 | 4.2 | 5 | 8 | 1.9 | 0 | 5.5 | 400 |
| Example 5 | S2 | 4.2 | 5 | 8 | 1.9 | 0 | 5.5 | 400 |
| Example 6 | S2 | 4.2 | 5 | 8 | 1.9 | 0 | 5.5 | 400 |
| Example 7 | S2 | 4.2 | 5 | 8 | 1.9 | 0 | 5 | 400 |
| Example 8 | S2 | 4.2 | 5 | 8 | 1.9 | 0 | 5.5 | 400 |
| Example 9 | S2 | 4.2 | 5 | 8 | 1.9 | 0 | 6 | 400 |
| Example 10 | S2 | 4.2 | 5 | 8 | 1.9 | 0 | 5.5 | 400 |
| Example 11 | S2 | 4.2 | 5 | 8 | 1.9 | 0 | 5.5 | 400 |
| Example 12 | S2 | 4.2 | 5 | 8 | 1.9 | −100 | 5.5 | 400 |
| Example 13 | S2 | 4.2 | 5 | 8 | 1.9 | 100 | 5.5 | 400 |
| Example 14 | S2 | 4.2 | 5 | 8 | 1.9 | 200 | 5.5 | 400 |
| Example 15 | S2 | 4.2 | 5 | 8 | 1.9 | 300 | 5.5 | 400 |
| Example 16 | S2 | 4.2 | 5 | 6 | 1.4 | 0 | 5.5 | 400 |
| Example 17 | S2 | 4.2 | 5 | 10 | 2.4 | 0 | 5.5 | 400 |
| Comparative | S2 | 4.2 | 5 | No | — | — | 5.5 | 400 |
| Example 2 | | | | | | | | |
| Comparative | S2 | 4.2 | 5 | No | — | — | 5 | 400 |
| Example 3 | | | | | | | | |
| Comparative | S2 | 4.2 | 5 | 8 | 1.9 | 0 | 5.5 | 400 |
| Example 4 | | | | | | | | |
| Comparative | S2 | 4.2 | 5 | 8 | 1.9 | 0 | 5.5 | 400 |
| Example 5 | | | | | | | | |
| Comparative | S2 | 4.2 | 5 | 8 | 1.9 | 0 | 5.5 | 400 |
| Example 6 | | | | | | | | |
| Comparative | S2 | 4.2 | 5 | 8 | 1.9 | 0 | 5.5 | 400 |
| Example 7 | | | | | | | | |
| Comparative | S2 | 4.2 | 5 | 8 | 1.9 | 0 | 5.5 | 400 |
| Example 8 | | | | | | | | |
| Comparative | S2 | 4.2 | 5 | 8 | 1.9 | 0 | 5.5 | 400 |
| Example 9 | | | | | | | | |
| Comparative | S2 | 4.2 | 5 | 8 | 1.9 | 0 | 5.5 | 400 |
| Example 10 | | | | | | | | |
| Comparative | S2 | 4.2 | 5 | 8 | 1.9 | 0 | 5.5 | 400 |
| Example 11 | | | | | | | | |

| | Subsequent energization | | | | | | Evaluation | |
|---|---|---|---|---|---|---|---|---|
| | Second | | | Electrode | | | | Internal |
| | current | Energization | | holding | | | Internal | crack of |
| | value I2 | time Tw2 | | time Tht | | | crack of | corona |
| | [kA] | [ms] | B | [ms] | C | D | nugget | bond |
| Example 1 | 3 | 400 | 0.60 | 160 | 280 | 394 | ∘ | ∘ |
| Example 2 | 3 | 400 | 0.60 | 160 | 280 | 394 | ∘ | ∘ |
| Comparative | No | | — | 160 | — | — | ∘ | x |
| Example 1 | | | | | | | | |
| Example 3 | 3 | 400 | 0.55 | 160 | 280 | 394 | ∘ | ∘ |
| Example 4 | 3 | 600 | 0.55 | 160 | 280 | 394 | ∘ | ∘ |
| Example 5 | 3 | 200 | 0.55 | 300 | 179 | 195 | ∘ | ∘ |
| Example 6 | 3 | 300 | 0.55 | 300 | 179 | 195 | ∘ | ∘ |
| Example 7 | 3 | 400 | 0.60 | 300 | 179 | 195 | ∘ | ∘ |
| Example 8 | 3 | 400 | 0.55 | 300 | 179 | 195 | ∘ | ∘ |
| Example 9 | 3 | 400 | 0.50 | 300 | 179 | 195 | ∘ | ∘ |
| Example 10 | 3 | 600 | 0.55 | 300 | 179 | 195 | ∘ | ∘ |
| Example 11 | 3 | 600 | 0.55 | 600 | 479 | 600 | ∘ | ∘ |
| Example 12 | 3 | 400 | 0.55 | 300 | 179 | 195 | ∘ | ∘ |
| Example 13 | 3 | 400 | 0.55 | 300 | 179 | 195 | ∘ | ∘ |
| Example 14 | 3 | 400 | 0.55 | 300 | 179 | 195 | ∘ | ∘ |
| Example 15 | 3 | 400 | 0.55 | 300 | 179 | 195 | ∘ | ∘ |
| Example 16 | 3 | 400 | 0.55 | 300 | 179 | 195 | ∘ | ∘ |
| Example 17 | 3 | 400 | 0.55 | 300 | 179 | 195 | ∘ | ∘ |
| Comparative | No | | — | 300 | — | | x | x |
| Example 2 | | | | | | | | |
| Comparative | 3 | 400 | 0.60 | 300 | 179 | 195 | ∘ | x |
| Example 3 | | | | | | | | |
| Comparative | 3 | 200 | 0.55 | 160 | 280 | 394 | x | x |
| Example 4 | | | | | | | | |
| Comparative | 3 | 100 | 0.55 | 300 | 179 | 195 | ∘ | x |
| Example 5 | | | | | | | | |
| Comparative | 3 | 1000 | 0.55 | 300 | 179 | 195 | ∘ | x |
| Example 6 | | | | | | | | |
| Comparative | 3 | 200 | 0.55 | 600 | 479 | 600 | ∘ | x |
| Example 7 | | | | | | | | |
| Comparative | 3 | 400 | 0.55 | 600 | 479 | 600 | ∘ | x |
| Example 8 | | | | | | | | |
| Comparative | 3 | 400 | 0.55 | 1000 | 1971 | 2904 | ∘ | x |
| Example 9 | | | | | | | | |
| Comparative | 3 | 600 | 0.55 | 1000 | 1971 | 2904 | ∘ | x |
| Example 10 | | | | | | | | |
| Comparative | 4 | 400 | 0.73 | 300 | 179 | 195 | ∘ | x |
| Example 11 | | | | | | | | |

As shown in Table 1, in Examples 1 to 17, the parameters of the second compressive force P2, the first current value I1, the main energization time Tw1, the second current value I2, the subsequent energization time Tw2, and the electrode holding time Tht satisfied the conditions of the above formulae (1) to (3), and thus neither the internal crack of a nugget nor the internal crack of a corona bond occurred. As a representative example, FIGS. 3, 5, and 6 show cross-sectional photographs showing welded portions of Example 1, Example 6, and Example 14, respectively.

On the other hand, in Comparative Example 1 and Comparative Example 2 in which, as the subsequent energization step after the main energization step, the second compressive force P2 greater than the first compressive force P1 was not applied and energization was not performed with the second current value I2 smaller than the first current value I1, at least one of the internal crack of a nugget and the internal crack of a corona bond crack occurred.

In addition, in Comparative Example 3 in which, as the subsequent energization step after the main energization step, energization was performed with the second current value I2 smaller than the first current value I1, but the second compressive force P2 greater than the first compressive force P1 was not applied, the internal crack of a corona bond occurred.

Furthermore, in Comparative Example 4, Comparative Example 5, and Comparative Examples 7 to 10, since C>Tw2 and the condition of the formula (3) was not satisfied, at least one of the internal crack of a nugget and the internal crack of a corona bond crack occurred. In addition, in Comparative Example 6, since Tw2=1000 and the condition of the formula (3) was not satisfied, the internal crack of a corona bond occurred.

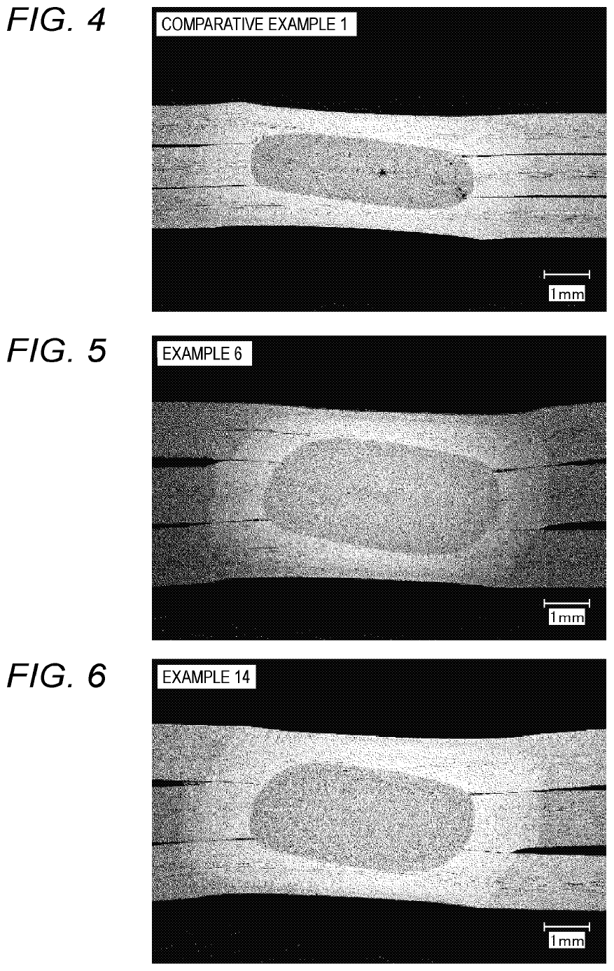

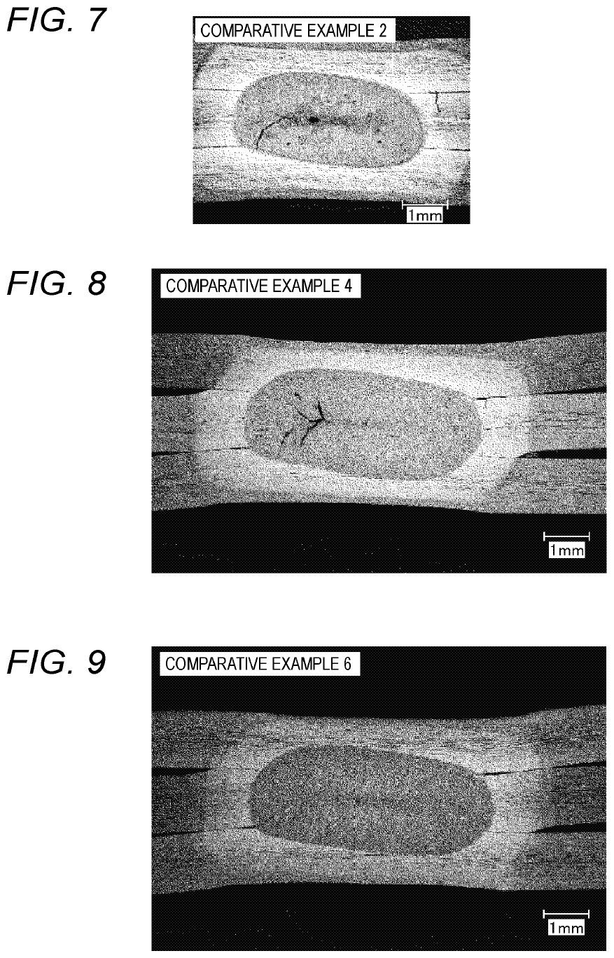

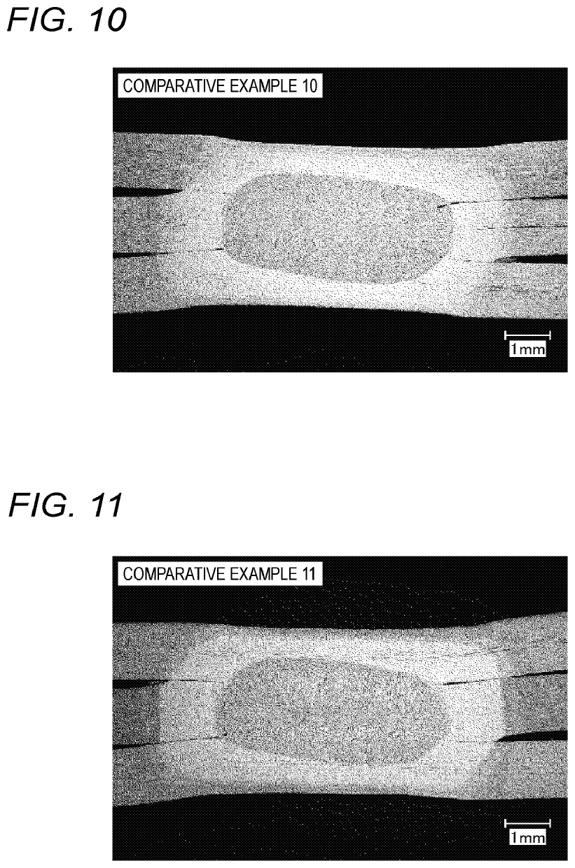

As a representative example, FIGS. 4, 7, 8, 9, 10, and 11 show cross-sectional photographs showing welded portions of Comparative Example 1, Comparative Example 2, Comparative Example 4, Comparative Example 6, Comparative Example 10, and Comparative Example 11, respectively.

In FIG. 2, a curve C indicates “Tw2=0.0039Tht²−2.51Tht+581.3”, and a curve D indicates “Tw2=0.0063Tht²−4.32Tht+923.87”. Referring to the result of FIG. 2, the technical significance of satisfying the condition of the formula (3) or (4) described above can be understood.

The present invention is not limited to the embodiments and examples described above, and modifications, improvements, and the like can be made as appropriate.

As described above, the present specification discloses the following matters.

(1) A method for producing a resistance-welded member made of three or more steel sheets including at least one plated high-tensile steel sheet having a base metal strength of 980 MPa or more, the method including:

a main energization step of performing energization with a first current value I1 while compressing the steel sheets with a first compressive force P1) to form a nugget;

a subsequent energization step of performing, after the main energization step, energization with a second current value I2 smaller than the first current value I1 while compressing the steel sheets with a second compressive force P2 greater than the first compressive force P1; and an electrode holding step of holding an electrode while maintaining the second compressive force (P2) after the subsequent energization, wherein the steel sheets are joined under conditions satisfying following formulae (1) to (3):

A≥1.4 Formula (1)

where A=P2/t, P2 represents the second compressive force [kN], and t represents a total sheet thickness [mm] of the steel sheets, respectively,

B<0.7 Formula (2)

where B=I2/I1, I1 represents the first current value [kA], and I2 represents the second current value [kA], respectively, and

C≤Tw2<1000 Formula (3)

where C=0.0039Tht²−2.51Tht+581.3, Tw2 represents an energization time [ms] in the subsequent energization step, and Tht represents an electrode holding time [ms] in the electrode holding step, respectively.

According to this configuration, in the spot welding of a set of three or more sheets including a plated steel sheet, it is possible to suppress the internal crack of a nugget and the internal crack of a corona bond.

(2) The method for producing a resistance-welded member according to (1), wherein the Tw2 and the Tht satisfy the following formula (4):

D≤Tw2<1000 Formula (4)

where D=0.0063Tht²−4.32Tht+923.87.

According to this configuration, the LME crack can be prevented by controlling the subsequent energization time Tw2 and the electrode holding time Tht within an appropriate range.

(3) The method for producing a resistance-welded member according to (1) or (2), wherein a compression rise delay time Td1 which is a time difference between an end of energization with the first current value I1 and a start of compression with the second compressive force P2 satisfies the following formula (5):

−100≤Td1≤300 Formula (5)

where Td1 represents the compression rise delay time [ms].

According to this configuration, the tensile stress generated in a heat-affected zone can be reduced.

(4) The method for producing a resistance-welded member according to any one of (1) to (3), wherein

a servo compression welding machine is used as a welding machine, and

when a depth of an indentation on the steel sheet by the electrode becomes 0.15 mm or more, control is performed to forcibly terminate only the energization or both the energization and the compression.

According to this configuration, it is possible to effectively prevent occurrence of expulsion even when the compression is performed with the second compressive force.

Although various embodiments have been described above with reference to the drawings, it is needless to say that the present invention is not limited to these examples. It will be apparent to those skilled in the art that various changes and modifications may be conceived within the scope of the claims. It is also understood that the various changes and modifications belong to the technical scope of the present invention. Constituent elements in the embodiments described above may be combined freely within a range not departing from the spirit of the present invention.

The present application is based on a Japanese patent application (No. 2020-073126) filed on Apr. 15, 2020, contents of which are incorporated by reference in the present application.

### REFERENCE SIGNS LIST

P1 First compressive force
P2 Second compressive force
I1 First current value
I2 Second current value
Tw1 Main energization time
Tw2 Subsequent energization time
Tht Electrode holding time

1. A method for producing a resistance-welded member made of three or more steel sheets including at least one plated high-tensile steel sheet having a base metal strength of 980 MPa or more, the method comprising:
a main energizing by performing energization with a first current value while compressing the steel sheets with a first compressive force to form a nugget;
a subsequent energizing by performing, after the main energizing, energization with a second current value smaller than the first current value while compressing the steel sheets with a second compressive force greater than the first compressive force; and
holding an electrode while maintaining the second compressive force after the subsequent energizing, wherein:
the steel sheets are joined under conditions satisfying formulae (1) to (3):
A≥1.4 Formula (1)
wherein A=P2/t;
P2 represents the second compressive force [kN]; and
t represents a total sheet thickness [mm] of the steel sheets, respectively;
B<0.7 Formula (2)
wherein B=I2/I1,
I1 represents the first current value [kA]; and
I2 represents the second current value [kA], respectively; and
C≤Tw2<1000 Formula (3)
wherein C=0.0039Tht²−2.51Tht+581.3;
Tw2 represents an energization time [ms] in the subsequent energizing; and
Tht represents an electrode holding time [ms] in the holding the electrode, respectively.

2. The method for producing a resistance-welded member according to claim 1, wherein the Tw2 and the Tht satisfy formula (4):
D≤Tw2<1000 Formula (4)
wherein D=0.0063Tht²−4.32Tht+923.87.

3. The method for producing a resistance-welded member according to claim 1, wherein a compression rise delay time which is a time difference between an end of energization with the first current value and a start of compression with the second compressive force (P2) satisfies formula (5):
−100≤Td1≤300 Formula (5)
wherein Td1 represents the compression rise delay time [ms].

4. The method for producing a resistance-welded member according to claim 1, wherein:
a servo compression welding machine is employed as a welding machine; and
when a depth of an indentation on the steel sheet by the electrode becomes 0.1.5 mm or more, a control is performed to forcibly terminate only the main energizing or both the main energizing and a compression.

5. The method for producing a resistance-welded member according to claim 2, wherein:
a servo compression welding machine is employed as a welding machine; and
when a depth of an indentation on the steel sheet by the electrode becomes 0.15 mm or more, a control is performed to forcibly terminate only the main energizing or both the main energizing and a compression.

6. The method for producing a resistance-welded member according to claim 2, wherein a compression rise delay time which is a time difference between an end of energization with the first current value and a start of compression with the second compressive force (P2) satisfies formula (5):
−100≤Td1≤300 Formula (5)
wherein Td1 represents the compression rise delay time [ms].

7. The method for producing a resistance-welded member according to claim 3, wherein:
a servo compression welding machine is employed as a welding machine; and
when a depth of an indentation on the steel sheet by the electrode becomes 0.15 mm or more, a control is performed to forcibly terminate only the main energizing or both the main energizing and a compression.

8. The method for producing a resistance-welded member according to claim 6, wherein:
a servo compression welding machine is employed as a welding machine; and
when a depth of an indentation on the steel sheet by the electrode becomes 0.15 mm or more, a control is performed to forcibly terminate only the main energizing or both the main energizing and a compression.
